(19) United States
(12) Patent Application Publication
(10) Pub. No.: US 2026/0358049 A1
(43) Pub. Date: Nov. 12, 2026

(54) TREATMENT DEVICE

(71) Applicant: SHARP KABUSHIKI KAISHA, Sakai City, Osaka (JP)

(72) Inventor: YUKISHIGE SHIRAICHI, Sakai City, Osaka (JP)

(21) Appl. No.: 19/514,984

(22) PCT Filed: Aug. 31, 2023
(86) PCT No.: PCT/JP2023/031713

§ 371 Date: Feb. 27, 2026

(51) Int. Cl. F26B 5/04

(52) U.S. Cl. CPC F26B 5/048

(57) ABSTRACT

A treatment device includes: a container having formed therein an internal space for accommodating an object to be treated, and an opening leading from the internal space to an outside of the container; a heating mechanism configured to heat the internal space; a decompression mechanism configured to decompress the internal space; a sensor configured to output a signal corresponding to infrared rays arriving from the internal space through the opening; and an opening/closing mechanism configured to switch a state between a first state, in which the opening is opened, and a second state, in which the opening is closed.

### TECHNICAL FIELD

The present disclosure relates to a treatment device.

### BACKGROUND ART

Patent Literature 1 discloses a microwave vacuum concentration/drying machine. In the microwave vacuum concentration/drying machine, a microwave irradiation device irradiates a concentrated/dried material stored in a concentration/drying chamber body with a microwave to concentrate/dry the concentrated/dried material. Further, a decompression device brings the atmosphere in the concentration/drying chamber body into a decompressed atmosphere. In addition, a product temperature detection sensor measures a product temperature of the concentrated/dried material during concentration/drying. A control device controls output of the microwave emitted from the microwave irradiation device based on the product temperature information (paragraphs 0026 and 0030).

### CITATION LIST

### Patent Literature

Patent Literature 1: JP 2022-128080 A

### SUMMARY OF INVENTION

### Technical Problem

In the microwave vacuum concentration/drying machine disclosed in Patent Literature 1, when the water vapor generated from the concentrated/dried material is not sufficiently discharged by the decompression device when the concentrated/dried material is concentrated/dried, the water vapor may cause the product temperature detection sensor to be fogged. When the water vapor fogs the product temperature detection sensor, the product temperature detection sensor cannot accurately detect the product temperature. Therefore, the control device cannot appropriately control the output of the microwave.

One aspect of the present disclosure has been made in view of this problem. An object of one aspect of the present disclosure is to provide a treatment device capable of accurately detecting a temperature.

### Solution to Problem

A treatment device according to one aspect of the present disclosure includes: a container having formed therein an internal space for accommodating an object to be treated, and an opening leading from the internal space to an outside of the container; a heating mechanism configured to heat the internal space; a decompression mechanism configured to decompress the internal space; a sensor configured to output a signal corresponding to infrared rays arriving from the internal space through the opening; and an opening/closing mechanism configured to switch a state between a first state, in which the opening is opened, and a second state, in which the opening is closed.

### BRIEF DESCRIPTION OF DRAWINGS

FIG. 1 is a diagram schematically illustrating a treatment device of a first embodiment.

FIG. 2 is a cross-sectional view schematically illustrating an upper wall of a shielding container, a sensor, and an opening/closing mechanism included in the treatment device of the first embodiment.

FIG. 3 is a cross-sectional view schematically illustrating the upper wall of the shielding container, the sensor, and the opening/closing mechanism included in the treatment device of the first embodiment.

FIG. 4 is a timing chart illustrating temporal changes of states of a heating mechanism, a decompression mechanism, and an opening/closing mechanism included in the treatment device of the first embodiment.

FIG. 5 is a cross-sectional view schematically illustrating states of the upper wall of the shielding container, the sensor, and the opening/closing mechanism included in the treatment device of the first embodiment when the treatment device performs an operation of drying an object to be treated.

FIG. 6 is a cross-sectional view schematically illustrating states of the upper wall of the shielding container, the sensor, and the opening/closing mechanism included in the treatment device of the first embodiment when the treatment device performs the operation of drying the object to be treated.

FIG. 7 is a cross-sectional view schematically illustrating states of the upper wall of the shielding container, the sensor, and the opening/closing mechanism included in the treatment device of the first embodiment when the treatment device performs the operation of drying the object to be treated.

FIG. 8 is a cross-sectional view schematically illustrating states of the upper wall of the shielding container, the sensor, and the opening/closing mechanism included in the treatment device of the first embodiment when the treatment device performs the operation of drying the object to be treated.

FIG. 9 is a cross-sectional view schematically illustrating states of the upper wall of the shielding container, the sensor, and the opening/closing mechanism included in the treatment device of the first embodiment when the treatment device performs the operation of drying the object to be treated.

FIG. 10 is a graph illustrating a temporal change of a temperature indicated by a signal output from the sensor included in the treatment device of the first embodiment when the treatment device performs the operation of drying the object to be treated.

### DESCRIPTION OF EMBODIMENTS

Hereinafter, embodiments of the present disclosure will be described with reference to the drawings. Note that, in the drawings, the same or equivalent elements are denoted by the same reference signs, and redundant description is omitted.

### 1 First Embodiment

### 1.1 Treatment Device

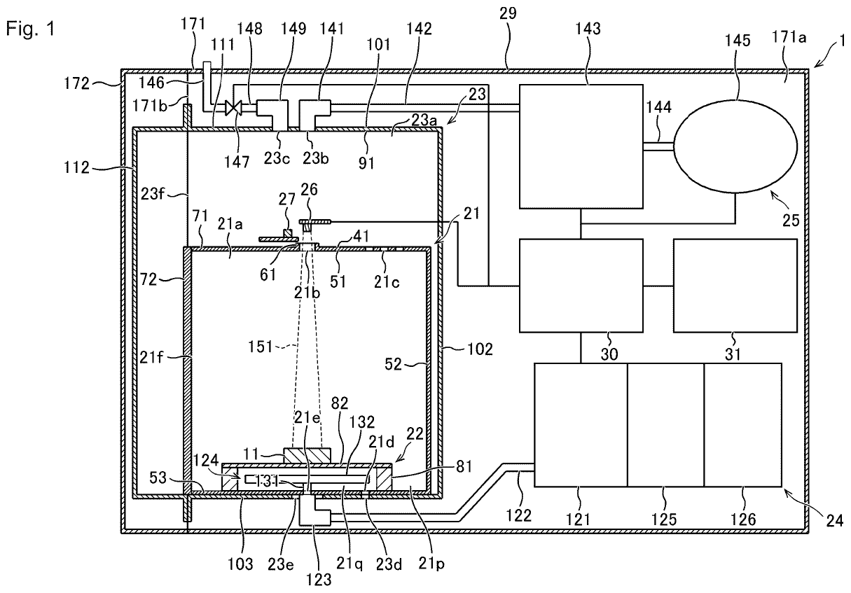

FIG. 1 is a diagram schematically illustrating a treatment device of a first embodiment.

A treatment device 1 of the first embodiment illustrated in FIG. 1 is a decompression drying apparatus. Therefore, the treatment device 1 accommodates an object to be treated 11 and heats and decompresses the space accommodating the object to be treated 11 to evaporate water from the object to be treated 11 and dry the object to be treated 11. The treatment device 1 detects the temperature of the object to be treated 11 and controls heating and decompression of the space based on the detected temperature. The treatment device 1 prevents water vapor generated by evaporating water from the object to be treated 11 from inhibiting temperature detection. The object to be treated 11 is not limited, but is, for example, a food or the like.

As illustrated in FIG. 1, the treatment device 1 includes a shielding container 21, a base 22, a vacuum container 23, a dielectric heating mechanism 24, a decompression mechanism 25, a sensor 26, an opening/closing mechanism 27, a housing 29, a controller 30, and a power source 31.

The shielding container 21 accommodates the object to be treated 11 and the base 22.

The base 22 supports the object to be treated 11.

The vacuum container 23 accommodates the object to be treated 11, the shielding container 21, the base 22, the sensor 26, and the opening/closing mechanism 27.

The dielectric heating mechanism 24 dielectrically heats the inside of the shielding container 21. As a result, the dielectric heating mechanism 24 dielectrically heats the object to be treated 11 disposed in the shielding container 21 to evaporate water from the object to be treated 11.

The decompression mechanism 25 decompresses the inside of the vacuum container 23. Accordingly, the decompression mechanism 25 decompresses the inside of the shielding container 21 disposed in the vacuum container 23. Accordingly, the decompression mechanism 25 lowers the boiling point of water in the shielding container 21. Accordingly, the decompression mechanism 25 evaporates water from the object to be treated 11 disposed in the shielding container 21.

The sensor 26 detects the temperature in the shielding container 21 or the opening/closing mechanism 27.

The opening/closing mechanism 27 prevents water vapor generated by evaporating water from the object to be treated 11 from fogging the sensor 26. As a result, the opening/closing mechanism 27 prevents the water vapor from hindering the detection of the temperature by the sensor 26.

The housing 29 accommodates the shielding container 21, the base 22, the vacuum container 23, the dielectric heating mechanism 24, the decompression mechanism 25, the sensor 26, the opening/closing mechanism 27, and the controller 30.

The controller 30 controls the dielectric heating mechanism 24, the decompression mechanism 25, and the opening/closing mechanism 27 based on the temperature detected by the sensor 26 to cause the treatment device 1 to dry the object to be treated 11 under decompression.

### 1.2 Shielding Container

As illustrated in FIG. 1, the shielding container 21 includes a wall 41. The wall 41 includes an upper wall 51, a side wall 52, and a lower wall 53.

The shielding container 21 shields microwaves. The wall 41 of the shielding container 21 includes a portion made of a conductor to shield microwaves. The conductor is, for example, a metal. Therefore, the wall 41 is made of, for example, a metal plate, a metal net, a punching metal, or the like.

In the shielding container 21, an internal space 21a, an opening 21b, an air vent 21c, an air vent 21d, and an opening 21e are formed.

The internal space 21a of the shielding container 21 is surrounded by the wall 41 of the shielding container 21. As described above, the wall 41 is made of a material that shields microwaves. Therefore, the wall 41 prevents leakage of microwaves from the internal space 21a to the outside of the shielding container 21.

The internal space 21a of the shielding container 21 includes a decompression space 21p and a non-decompression space 21q. The decompression space 21p is defined by the upper wall 51 of the shielding container 21, the side wall 52 of the shielding container 21, the peripheral portion of the lower wall 53 of the shielding container 21, and a base 22. The non-decompression space 21q is defined by the central portion of the lower wall 53 of the shielding container 21 and the base 22. The decompression space 21p and the non-decompression space 21q are separated from each other by the base 22. The decompression space 21p is a first internal space for accommodating the object to be treated 11.

The opening 21b of the shielding container 21 is formed in the upper wall 51 of the shielding container 21. The opening 21b penetrates the upper wall 51 in its thickness direction. The opening 21b extends from the decompression space 21p of the shielding container 21 to the outside of the shielding container 21. As a result, the opening 21b allows infrared rays to pass and guides the infrared rays from the decompression space 21p to the outside of the shielding container 21. As a result, the infrared rays can be detected outside the shielding container 21. As a result, the temperature of the decompression space 21p can be detected outside the shielding container 21.

As illustrated in FIG. 1, the upper wall 51 of the shielding container 21 includes a protruding portion 61.

The protruding portion 61 protrudes toward the outside of the shielding container 21. The protruding portion 61 has a ring shape. The opening 21b of the shielding container 21 penetrates the protruding portion 61. The protruding portion 61 includes a portion made of a conductor. As a result, it is possible to prevent leakage of microwaves through the opening 21b.

The air vent 21c of the shielding container 21 is formed in the upper wall 51 of the shielding container 21. The air vent 21c penetrates the upper wall 51 in its thickness direction. The air vent 21c extends from the decompression space 21p of the shielding container 21 to the outside of the shielding container 21. The air vent 21c allows air to pass therethrough and guides the air from the decompression space 21p to the outside of the shielding container 21. As a result, the decompression space 21p can be decompressed from the outside of the shielding container 21.

The air vent 21d of the shielding container 21 is formed in a central portion of the lower wall 53 of the shielding container 21. The air vent 21d penetrates the lower wall 53 in its thickness direction. The air vent 21d extends from the non-decompression space 21q of the shielding container 21 to the outside of the shielding container 21. The air vent 21d allows air to pass therethrough and allows the air to flow between the non-decompression space 21q and the outside of the shielding container 21.

The opening 21e of the shielding container 21 is formed in the central portion of the lower wall 53 of the shielding container 21. The opening 21e penetrates the lower wall 53 in its thickness direction. The opening 21e extends from the non-decompression space 21q of the shielding container 21 to the outside of the shielding container 21.

As illustrated in FIG. 1, the shielding container 21 includes a main body 71 and a door 72.

In the main body 71 of the shielding container 21, the internal space 21a, the opening 21b, the air vent 21c, the air vent 21d, and the opening 21e are formed. In addition, the opening 71a is formed in the main body 71.

When the opening 71a of the main body 71 of the shielding container 21 is not closed by the door 72 of the shielding container 21, the internal space 21a of the shielding container 21 is exposed to the outside of the main body 71 of the shielding container 21. Thus, when the opening 71a is not closed by the door 72, the object to be treated 11 can be put into the internal space 21a from the outside of the main body 71 through the opening 71a, and the object to be treated 11 can be taken out from the internal space 21a to the outside of the main body 71 through the opening 71a.

The door 72 of the shielding container 21 can move between a closed position of closing the opening 71a of the main body 71 of the shielding container 21 and an open position of not closing the opening 71a. When disposed at the closed position, the door 72 becomes a part of the side wall 52 of the shielding container 21.

### 1.3 Base

The base 22 is accommodated in the internal space 21a of the shielding container 21 and is placed on the central portion of the lower wall 53 of the shielding container 21.

As illustrated in FIG. 1, the base 22 includes a support 81 and a top plate 82.

The support 81 is disposed on a central portion of the lower wall 53 of the shielding container 21. The support 81 supports a peripheral portion of the top plate 82 from below.

The peripheral portion of the top plate 82 is placed on the support 81.

As a result, a space defined by the upper wall 51 of the shielding container 21, the side wall 52 of the shielding container 21, the peripheral portion of the lower wall 53 of the shielding container 21, the support 81, and the top plate 82 is formed, and a space defined by the central portion of the lower wall 53 of the shielding container 21, the support 81, and the top plate 82 is formed. The support 81 and the top plate 82 separate the former space and the latter space from each other, and inhibit air from flowing between the former space and the latter space. As a result, the support 81 and the top plate 82 set the former space as the decompression space 21p of the shielding container 21 and the latter space as the non-decompression space 21q of the shielding container 21.

The object to be treated 11 is placed on the top plate 82. As a result, the base 22 supports the object to be treated 11 in a state of floating from the lower wall 53 of the shielding container 21.

The top plate 82 is made of a material that transmits microwaves. The material is, for example, a dielectric, and is desirably a dielectric having a low dielectric loss. The dielectric having a low dielectric loss is, for example, ceramic glass, fluororesin, or the like. As a result, the top plate 82 transmits microwaves and allows the microwaves to reach the object to be treated 11 disposed above the top plate 82 from the non-decompression space 21q of the shielding container 21 formed below the top plate 82.

### 1.4 Vacuum Container

As illustrated in FIG. 1, the vacuum container 23 includes a wall 91. The wall 91 includes an upper wall 101, a side wall 102, and a lower wall 103.

In the vacuum container 23, an internal space 23a, an exhaust port 23b, an intake port 23c, an air vent 23d, and an opening 23e of the vacuum container 23 are formed.

The vacuum container 23 has airtightness capable of decompressing the internal space 23a.

The internal space 23a of the vacuum container 23 is surrounded by the wall 91 of the vacuum container 23. The internal space 23a is defined by the upper wall 101, the side wall 102, and the lower wall 103 of the vacuum container 23. The internal space 23a is a second internal space that accommodates the object to be treated 11, the shielding container 21, the base 22, the sensor 26, and the opening/closing mechanism 27. The internal space 23a accommodates the shielding container 21 in a state where the lower wall 53 of the shielding container 21 is placed on the lower wall 103 of the vacuum container 23.

The exhaust port 23b of the vacuum container 23 is formed in the upper wall 101 of the vacuum container 23. The exhaust port 23b penetrates the upper wall 101 in its thickness direction. As a result, the exhaust port 23b reaches the outside of the vacuum container 23 from the internal space 23a of the vacuum container 23. As a result, the exhaust port 23b allows air to pass and guides the air from the internal space 23a to the outside of the vacuum container 23. As a result, the internal space 23a can be decompressed from the outside of the vacuum container 23.

The intake port 23c of the vacuum container 23 is formed in the upper wall 101 of the vacuum container 23. The intake port 23c penetrates the upper wall 101 in its thickness direction. As a result, the intake port 23c reaches the internal space 23a of the vacuum container 23 from the outside of the vacuum container 23. As a result, the intake port 23c allows air to pass and guides the air from the outside of the vacuum container 23 to the internal space 23a. Accordingly, the state where the internal space 23a is decompressed can be released from the outside of the vacuum container 23.

The air vent 23d of the vacuum container 23 is formed in a central portion of the lower wall 103 of the vacuum container 23. The air vent 23d penetrates the lower wall 103 in its thickness direction. The air vent 23d extends from the internal space 23a of the vacuum container 23 to the outside of the vacuum container 23. The air vent 23d allows air to pass therethrough and allows the air to flow between the internal space 23a and the outside of the vacuum container 23. The air vent 23d of the vacuum container 23 is connected to the air vent 21c of the shielding container 21. As a result, the air vent 21d of the shielding container 21 and the air vent 23d of the vacuum container 23 pass air from the non-decompression space 21q of the shielding container 21 to the outside of the vacuum container 23 and allow the air to flow between the non-decompression space 21q and the outside of the vacuum container 23. As a result, the air pressure in the non-decompression space 21q is maintained at approximately the atmospheric pressure. As a result, the heating element accommodated in the non-decompression space 21q can be cooled by the air present in the non-decompression space 21q.

The opening 23e of the vacuum container 23 is formed in a central portion of the lower wall 103 of the vacuum container 23. The opening 23e penetrates the lower wall 103 in its thickness direction. The opening 23e extends from the internal space 23a of the vacuum container 23 to the outside of the vacuum container 23. The opening 23e of the vacuum container 23 is connected to the opening 21e of the shielding container 21. As a result, the opening 21e of the shielding container 21 and the opening 23e of the vacuum container 23 reach the outside of the vacuum container 23 from the non-decompression space 21q of the shielding container 21.

As illustrated in FIG. 1, the vacuum container 23 includes a main body 111 and a door 112.

In the main body 111 of the vacuum container 23, the intake port 23c, the exhaust port 23b, the air vent 23d, and the opening 23e of the vacuum container 23 are formed. In addition, an opening 111a is formed in the main body 111.

When the opening 111a of the main body 111 of the vacuum container 23 is not closed by the door 112 of the vacuum container 23, the internal space 23a of the vacuum container 23 is exposed to the outside of the main body 111.

The door 112 of the vacuum container 23 can move between a closed position where the door 112 closes the opening 111a of the main body 111 of the vacuum container 23 and an open position where the door 112 does not close the opening 111a. When disposed at the closed position, the door 112 becomes a part of the side wall 102 of the vacuum container 23.

### 1.5 Dielectric Heating Mechanism

The dielectric heating mechanism 24 radiates microwaves to the internal space 21a of the shielding container 21 to dielectrically heat the internal space 21a. The dielectric heating mechanism 24 may be replaced with a heating mechanism other than the dielectric heating mechanism. For example, the dielectric heating mechanism 24 may be replaced with an induction heating mechanism that generates an AC magnetic field in the internal space 21a to inductively heat the internal space 21a. When the dielectric heating mechanism 24 is replaced with an induction heating mechanism, the shielding container 21 that shields microwaves is replaced with a shielding container that shields an AC magnetic field.

As illustrated in FIG. 1, the dielectric heating mechanism 24 includes a high-frequency oscillation circuit 121, a coaxial cable 122, a cable connector 123, an antenna 124, a heat sink 125, and a cooling fan 126.

The high-frequency oscillation circuit 121, the coaxial cable 122, the heat sink 125, and the cooling fan 126 are disposed outside the vacuum container 23. The cable connector 123 is disposed across the opening 23e of the vacuum container 23 and the outside of the vacuum container 23. The antenna 124 is disposed across the non-decompression space 21q of the shielding container 21, the opening 21e of the shielding container 21, the opening 23e of the vacuum container 23, and the outside of the vacuum container 23.

The high-frequency oscillation circuit 121 oscillates high-frequency power. The high-frequency oscillation circuit 121 includes a power semiconductor for oscillating high-frequency power. The power semiconductor is, for example, a gallium nitride (GaN) semiconductor or the like.

One end of the coaxial cable 122 is connected to the high-frequency oscillation circuit 121. The other end of the coaxial cable 122 is connected to the cable connector 123. The cable connector 123 is connected to the antenna 124. As a result, the coaxial cable 122 and the cable connector 123 transmit the oscillated high-frequency power from the high-frequency oscillation circuit 121 to the antenna 124.

As illustrated in FIG. 1, the antenna 124 includes an antenna connector 131 and an antenna body 132.

The antenna connector 131 is disposed across the non-decompression space 21q of the shielding container 21, the opening 21e of the shielding container 21, the opening 23e of the vacuum container 23, and the outside of the vacuum container 23. The antenna body 132 is disposed in the non-decompression space 21q.

The cable connector 123 is connected to the antenna connector 131. The antenna connector 131 supplies the transmitted high-frequency power to the antenna body 132.

The antenna body 132 emits microwaves corresponding to the supplied high-frequency power. The antenna body 132 radiates microwaves to the non-decompression space 21q of the shielding container 21, and radiates microwaves to the decompression space 21p of the shielding container 21 through the top plate 82. Most of the microwaves radiated to the non-decompression space 21q and the decompression space 21p are shielded by the wall 41 of the shielding container 21. Therefore, most of the microwave does not leak out of the shielding container 21.

The antenna 124 is, for example, a patch antenna.

The antenna 124 is disposed at a position where a distance from the antenna 124 to the object to be treated 11 placed on the top plate 82 is equal to or less than one wavelength of the radiated microwave. Accordingly, the object to be treated 11 can be efficiently heated. In addition, the treatment device 1 can be downsized.

As described above, the air pressure of the non-decompression space 21q of the shielding container 21 in which the antenna body 132 is disposed is maintained at substantially the atmospheric pressure. Thus, the antenna body 132 can be efficiently cooled by the air present in the non-decompression space 21q.

The heat sink 125 dissipates heat generated by the high-frequency oscillation circuit 121.

The cooling fan 126 sends air hitting the heat sink 125.

In a case where the high-frequency oscillation circuit 121 includes a GaN semiconductor and the dielectric heating mechanism 24 has the above-described configuration, the dielectric heating mechanism 24 can be downsized.

The treatment device 1 may include a plurality of dielectric heating mechanisms 24. In a case where the dielectric heating mechanism 24 can be downsized as described above, it is easy to provide the plurality of dielectric heating mechanisms 24 in the treatment device 1. When the treatment device 1 includes the plurality of dielectric heating mechanisms 24, selective heating in which microwaves are radiated from the dielectric heating mechanism 24 selected from the plurality of dielectric heating mechanisms 24, uniform heating in which microwaves are radiated all at once from all of the plurality of dielectric heating mechanisms 24, and the like can be performed.

The dielectric heating mechanism 24 may have a configuration other than the above-described elements. For example, the dielectric heating mechanism 24 may include a magnetron.

### 1.6 Decompression Mechanism

The decompression mechanism 25 decompresses the internal space 23a of the vacuum container 23. As a result, the decompression mechanism 25 decompresses the decompression space 21p of the shielding container 21 communicating with the internal space 23a of the vacuum container 23 through the air vent 21c of the shielding container 21.

As illustrated in FIG. 1, the decompression mechanism 25 includes a vacuum nipple 141, a vacuum hose 142, a cold trap 143, a vacuum hose 144, a vacuum pump 145, a vacuum hose 146, a pressure regulating valve 147, and a vacuum hose 148.

One end of the vacuum hose 142 is connected to the vacuum nipple 141. The vacuum nipple 141 is attached to the vacuum container 23. The other end of the vacuum hose 142 is connected to the cold trap 143. As a result, the vacuum nipple 141 and the vacuum hose 142 guide air from the decompression space 21p of the shielding container 21 to the cold trap 143.

The cold trap 143 removes water contained in the guided air.

One end of the vacuum hose 144 is connected to the cold trap 143. The other end of the vacuum hose 144 is connected to the vacuum pump 145. As a result, the vacuum hose 144 guides the air from which the water has been removed from the cold trap 143 to the vacuum pump 145.

The vacuum pump 145 generates an air flow flowing from the decompression space 21p of the shielding container 21 to the outside of the vacuum pump 145 through the air vent 21c of the shielding container 21, the internal space 23a of the vacuum container 23, the vacuum nipple 141, the vacuum hose 142, the cold trap 143, the vacuum hose 144, and the vacuum pump 145. As a result, the air existing in the decompression space 21p can be exhausted to the outside of the vacuum pump 145. As a result, the decompression space 21p can be decompressed.

One end of the vacuum hose 146 is disposed outside the housing 29. The other end of the vacuum hose 146 is connected to the pressure regulating valve 147. As a result, the vacuum hose 146 guides air from the outside of the housing 29 to the pressure regulating valve 147.

The pressure regulating valve 147 allows the guided air to pass.

One end of the vacuum hose 148 is connected to the pressure regulating valve 147. The other end of the vacuum hose 148 is connected to the vacuum nipple 149. The vacuum nipple 149 is attached to the vacuum container 23. As a result, the vacuum hose 148 and the vacuum nipple 149 guide the passing air from the pressure regulating valve 147 to the decompression space 21p of the shielding container 21. As a result, the state in which the decompression space 21p is decompressed can be released.

The decompression mechanism 25 does not directly decompress the decompression space 21p of the shielding container 21, but decompresses the decompression space 21p through the internal space 23a of the vacuum container 23. When the decompression mechanism 25 directly decompresses the decompression space 21p, the exhaust port and the intake port are formed in the wall 41 of the shielding container 21. For this reason, there is a possibility that the formed exhaust port and intake port hinder application of sufficient microwave shielding property to the shielding container 21. When the decompression mechanism 25 directly decompresses the decompression space 21p, the vacuum nipple 141 and the vacuum nipple 149 are attached to the shielding container 21. Therefore, the vacuum nipple 141 and the vacuum nipple 149 need to be made of a material that does not significantly affect microwave shielding, for example, a non-metal. For this reason, there is a possibility that sufficient airtightness cannot be imparted to the shielding container 21. On the other hand, when the decompression mechanism 25 decompresses the decompression space 21p through the internal space 23a, the exhaust port 23b and the intake port 23c are formed in the wall 91 of the vacuum container 23. Therefore, the formed exhaust port 23b and intake port 23c do not inhibit the shielding container 21 from being provided with sufficient microwave shielding properties. When the decompression mechanism 25 decompresses the decompression space 21p through the internal space 23a, the vacuum nipple 141 and the vacuum nipple 149 are attached to the vacuum container 23. Therefore, the vacuum nipple 141 and the vacuum nipple 149 may not be made of a material that does not significantly affect microwave shielding. Therefore, sufficient airtightness can be imparted to the shielding container 21. However, the vacuum container 23 may be omitted, and the decompression mechanism 25 may directly decompress the decompression space 21p.

### 1.7 Sensor

The sensor 26 outputs a signal corresponding to the received infrared rays. The sensor 26 is disposed above the opening 21b of the shielding container 21. Accordingly, the sensor 26 faces the opening 21b. As a result, when the opening 21b is open, the sensor 26 receives infrared rays arriving from the internal space 21a of the shielding container 21 through the opening 21b, and outputs a signal corresponding to the received infrared rays. The output signal indicates the temperature of the internal space 21a. Thus, the sensor 26 constitutes an infrared temperature sensor that indicates the temperature of the internal space 21a.

The sensor 26 receives infrared rays coming from an object disposed within a visual field 151 of the sensor 26. The object to be treated 11 placed on the top plate 82 is disposed within the visual field 151 when the opening 21b of the shielding container 21 is open. Thus, the output signal indicates the temperature of the object to be treated 11 when the opening 21b is open.

### 1.8 Opening/Closing Mechanism

The opening/closing mechanism 27 switches the opening/closing state of the opening 21b between a first state of opening the opening 21b of the shielding container 21 and a second state of closing the opening 21b.

When the opening/closing mechanism 27 sets the opening/closing state of the opening 21b of the shielding container 21 to the first state, the sensor 26 and the internal space 21a of the shielding container 21 are not separated from each other. Therefore, the sensor 26 can see the internal space 21a through the opening 21b. Therefore, the sensor 26 receives first infrared rays arriving from the internal space 21a through the opening 21b, and outputs a signal corresponding to the received first infrared rays. Therefore, the sensor 26 detects the temperature of the internal space 21a. When the opening/closing mechanism 27 sets the opening/closing state of the opening 21b to the first state, there is a possibility that water vapor generated in the internal space 21a reaches the sensor 26 through the opening 21b and fogs the sensor 26.

When the opening/closing mechanism 27 sets the opening/closing state of the opening 21b of the shielding container 21 to the second state, the sensor 26 and the internal space 21a of the shielding container 21 are separated from each other by the opening/closing mechanism 27. Therefore, the sensor 26 cannot see the internal space 21a through the opening 21b. Therefore, the sensor 26 receives second infrared rays arriving from the opening/closing mechanism 27 and outputs a signal corresponding to the received second infrared rays. Therefore, the sensor 26 detects the temperature of the opening/closing mechanism 27. When the opening/closing mechanism 27 sets the opening/closing state of the opening 21b to the second state, the water vapor generated in the internal space 21a does not reach the sensor 26 through the opening 21b, and the sensor 26 is not fogged.

Even when the opening 21b of the shielding container 21 is closed, the opening/closing mechanism 27 does not close the air vent 21c of the shielding container 21. Therefore, the air vent 21c is not closed even when the opening/closing state of the opening 21b becomes the second state. As a result, even when the opening/closing state of the opening 21b is set to the second state in order to prevent the sensor 26 from fogging, the air can be discharged from the decompression space 21p of the shielding container 21 through the air vent 21c. As a result, even when the opening/closing state of the opening 21b is set to the second state in order to prevent the sensor 26 from fogging, it is possible to continue to decompress the decompression space 21p. The air vent 21c is separated from the sensor 26 and the opening 21b to such an extent that water vapor from the air vent 21c does not fog the sensor 26.

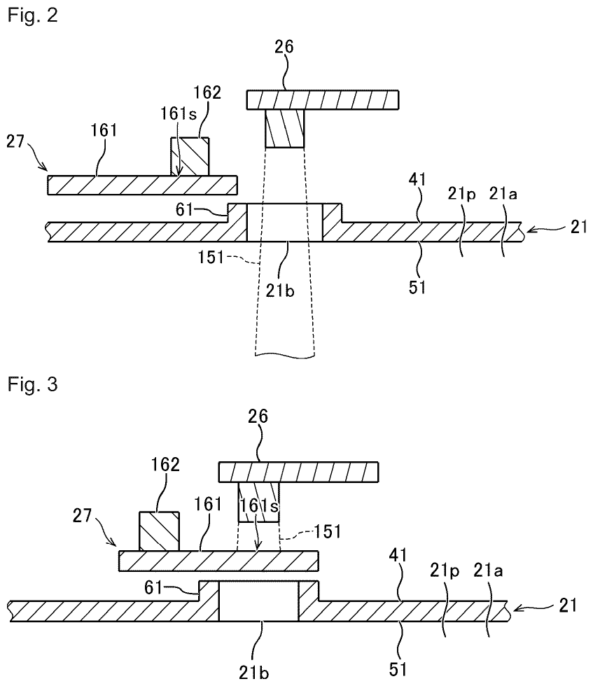

FIGS. 2 and 3 are cross-sectional views schematically illustrating the upper wall of the shielding container, the sensor, and the opening/closing mechanism included in the treatment device of the first embodiment.

FIG. 2 is a cross-sectional view of a case where the opening/closing state of the opening 21b of the shielding container 21 is set to the first state. FIG. 3 is a cross-sectional view of a case where the opening/closing state of the opening 21b is set to the second state.

As illustrated in FIGS. 2 and 3, the opening/closing mechanism 27 includes a lid 161 and a moving mechanism 162.

The lid 161 is made of a material that does not transmit water vapor. Therefore, when the lid 161 closes the opening 21b of the shielding container 21, it is possible to prevent the water vapor generated in the internal space 21a of the shielding container 21 from flowing toward the sensor 26.

The lid 161 includes a portion made of a conductor. The conductor is, for example, a metal. The portion may be the entire lid 161 or a part of the lid 161. The portion made of the conductor is not heated by microwaves.

The lid 161 has a plate shape.

The lid 161 is disposed at a position outside the shielding container 21 and along the outer surface of the upper wall 51 of the shielding container 21. The lid 161 may be disposed at a position in the shielding container 21 and along the inner surface of the upper wall 51.

The moving mechanism 162 moves the lid 161 between a first position where the opening 21b of the shielding container 21 illustrated in FIG. 2 is not closed and a second position where the opening 21b illustrated in FIG. 3 is closed. The moving mechanism 162 moves the lid 161 between the first position and the second position by sliding the lid 161. The moving mechanism 162 may rotate the lid 161 to move the lid 161 between a first position where the opening 21b is not closed and a second position where the opening 21b is closed. The lid 161 disposed at the second position approaches the upper end of the protruding portion 61 to bring the opening 21b close to the sealed state, and desirably comes into contact with the upper end of the protruding portion 61 to bring the opening 21b into the sealed state.

When the moving mechanism 162 moves the lid 161 to the first position, the opening/closing mechanism 27 sets the opening/closing state of the opening 21b of the shielding container 21 to the first state. When the moving mechanism 162 moves the lid 161 to the second position, the opening/closing mechanism 27 sets the opening/closing state of the opening 21b to the second state.

The moving mechanism 162 includes an actuator, a transmission mechanism, and the like. The actuator generates a driving force necessary for moving the lid 161. The actuator is, for example, an electromagnetic motor, a piezoelectric actuator, an air actuator, or the like. The transmission mechanism transmits the generated driving force to the lid 161 to apply the driving force to the lid 161. The transmission mechanism is, for example, a gear, a belt, a pulley, a chain, a shaft, a shaft joint, or the like. The transmission mechanism may be omitted, and the driving force generated by the actuator may be directly applied to the lid 161.

The visual field 151 of the sensor 26 is not obstructed by the lid 161 when the lid 161 is disposed at the first position. Therefore, when the lid 161 is disposed at the first position, the sensor 26 receives the first infrared rays arriving from the internal space 21a of the shielding container 21 through the opening 21b of the shielding container 21, and outputs a signal corresponding to the received first infrared rays. As a result, the sensor 26 detects the temperature of the internal space 21a.

The visual field 151 of the sensor 26 is obstructed by the lid 161 when the lid 161 is disposed at the second position. Therefore, when the lid 161 is disposed at the second position, the sensor 26 receives the second infrared rays arriving from the lid 161 and outputs a signal corresponding to the received second infrared rays. Thus, the sensor 26 detects the temperature of the lid 161.

The lid 161 has a surface 161s that is disposed at the visual field 151 of the sensor 26 when the lid 161 is disposed at the second position. The surface 161s exhibits black color. Accordingly, when the lid 161 is disposed at the second position, the sensor 26 receives infrared rays emitted from the surface 161s that exhibits black color. Thus, the sensor 26 can accurately detect the temperature of the lid 161 when the lid 161 is disposed at the second position. The surface 161s that exhibits black color can be formed by, for example, applying black paint to the base surface.

### 1.9 Housing

As illustrated in FIG. 1, the housing 29 includes a main body 171 and a door 172.

In the main body 171 of the housing 29, an internal space 171a and an opening 171b are formed.

The internal space 171a of the main body 171 of the housing 29 accommodates the main body 71 of the shielding container 21, the base 22, the main body 111 of the vacuum container 23, the dielectric heating mechanism 24, the decompression mechanism 25, the sensor 26, the opening/closing mechanism 27, and the controller 30.

The door 172 of the housing 29 can move between a closed position where the door 172 closes the opening 171b of the main body 171 of the housing 29 and an open position where the door 172 does not close the opening 171b of the main body 171 of the housing 29. The door 72 of the shielding container 21 and the door 112 of the vacuum container 23 are attached to the door 172 of the housing 29. When the door 72 of the shielding container 21 and the door 112 of the vacuum container 23 are disposed at the closed positions of closing the opening 71a of the main body 71 of the shielding container 21 and the opening 111a of the main body 111 of the vacuum container 23, respectively, the door 172 of the housing 29 is disposed at the closed position of closing the opening 171b of the main body 171 of the housing 29. When the door 72 of the shielding container 21 and the door 112 of the vacuum container 23 are disposed at the open positions of not closing the opening 71a of the main body 71 of the shielding container 21 and the opening 111a of the main body 111 of the vacuum container 23, respectively, the door 172 of the housing 29 is disposed at the open position of not closing the opening 171b of the main body 171 of the housing 29.

### 1.10 Controller

The controller 30 generates power to be supplied to the high-frequency oscillation circuit 121 from the supplied power. The controller 30 controls the dielectric heating mechanism 24 by controlling power supplied to the high-frequency oscillation circuit 121. When causing the dielectric heating mechanism 24 to start heating the internal space 21a of the shielding container 21, the controller 30 causes the high-frequency oscillation circuit 121 to start oscillating high-frequency power. When causing the dielectric heating mechanism 24 to end heating the internal space 21a, the controller 30 causes the high-frequency oscillation circuit 121 to end oscillating the high-frequency power.

The controller 30 generates electric power to be supplied to the cold trap 143, the vacuum pump 145, and the pressure regulating valve 147 from the supplied electric power. The controller 30 controls the decompression mechanism 25 by controlling electric power supplied to the cold trap 143, the vacuum pump 145, and the pressure regulating valve 147. When causing the decompression mechanism 25 to start decompressing the decompression space 21p of the shielding container 21, the controller 30 closes the pressure regulating valve 147 to end passing of air through the pressure regulating valve 147, and causes the vacuum pump 145 to start generating an air flow. When causing the decompression mechanism 25 to end decompressing the decompression space 21p, the controller 30 causes the vacuum pump 145 to end generating the air flow, opens the pressure regulating valve 147, and causes the pressure regulating valve 147 to start passing the air.

The controller 30 generates electric power to be supplied to the moving mechanism 162 from the supplied electric power. The controller 30 controls the opening/closing mechanism 27 by controlling power supplied to the moving mechanism 162. When causing the opening/closing mechanism 27 to set the opening/closing state of the opening 21b of the shielding container 21 to the first state, the controller 30 causes the moving mechanism 162 to move the lid 161 to the first position. When causing the opening/closing mechanism 27 to bring the opening/closing state of the opening 21b into the second state, the controller 30 causes the moving mechanism 162 to move the lid 161 to the second position.

The controller 30 acquires a signal output from the sensor 26 and acquires a temperature indicated by the acquired signal.

### 1.11 Power Source

The power source 31 supplies power to the controller 30.

### 1.12 Operation of Controller

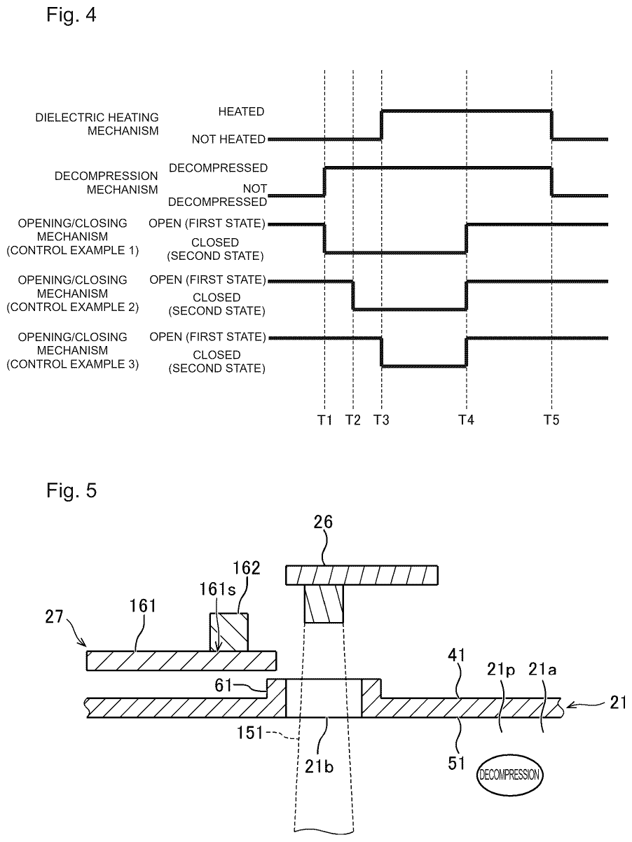

FIG. 4 is a timing chart illustrating time changes of states of the heating mechanism, the decompression mechanism, and the opening/closing mechanism included in the treatment device of the first embodiment. FIG. 4 illustrates a time change of the state of the opening/closing mechanism for each of Control Example 1, Control Example 2, and Control Example 3.

As illustrated in FIG. 4, when the treatment device 1 dries the object to be treated 11, the controller 30 causes the decompression mechanism 25 to start depressurizing the decompression space 21p of the shielding container 21 at timing T1. The controller 30 causes the dielectric heating mechanism 24 to start heating the internal space 21a of the shielding container 21 at timing T3 after timing T1. At timing T5 after timing T3, the controller 30 causes the dielectric heating mechanism 24 to end heating the internal space 21a and causes the decompression mechanism 25 to end decompressing the decompression space 21p. The timing at which the decompression mechanism 25 ends decompressing the decompression space 21p may be different from the timing at which the dielectric heating mechanism 24 ends heating the internal space 21a.

As in Control Example 1, the controller 30 causes the opening/closing mechanism 27 to switch the opening/closing state of the opening 21b of the shielding container 21 from the first state to the second state at timing T1. Alternatively, as in Control Example 2, the controller 30 causes the opening/closing mechanism 27 to switch the opening/closing state of the opening 21b from the first state to the second state at timing T2 after timing T1 and before timing T3. Alternatively, as in Control Example 3, the controller 30 causes the opening/closing mechanism 27 to switch the opening/closing state of the opening 21b from the first state to the second state at timing T3. Therefore, the controller 30 causes the opening/closing mechanism 27 to switch the opening/closing state of the opening 21b from the first state to the second state after causing the decompression mechanism 25 to start decompressing the decompression space 21p of the shielding container 21 or at the same time as causing the decompression mechanism 25 to start decompressing the decompression space 21p. In addition, before causing the dielectric heating mechanism 24 to start heating the decompression space 21p or at the same time as causing the dielectric heating mechanism 24 to start heating the decompression space 21p, the controller 30 causes the opening/closing mechanism 27 to switch the opening/closing state of the opening 21b from the first state to the second state. As a result, before there is a high possibility that water vapor generated by evaporating water from the object to be treated 11 will fog the sensor 26, the controller 30 causes the sensor 26 to receive infrared rays arriving from the object to be treated 11 and acquires the temperature of the object to be treated 11. In addition, the controller 30 prevents the sensor 26 from being fogged by preventing the water vapor from reaching the sensor 26 after the possibility that the water vapor may cause the sensor 26 to be fogged becomes high. As a result, the temperature of the object to be treated 11 can be accurately detected.

As in Control Examples 1, 2, and 3, the controller 30 causes the opening/closing mechanism 27 to switch the opening/closing state of the opening 21b of the shielding container 21 from the second state to the first state at timing T4 after timing T3 and before timing T5. Timing T4 is a timing at which the possibility that the water vapor will fog the sensor 26 becomes low. As a result, after the possibility that water vapor generated by evaporating water from the object to be treated 11 causes the sensor 26 to be fogged becomes low, the controller 30 causes the sensor 26 to receive infrared rays arriving from the object to be treated 11 and acquires the temperature of the object to be treated 11.

The controller 30 is implemented by a microcontroller and a peripheral circuit. The microcontroller includes a processor and a memory. The processor executes a control program stored in the memory to operate the microcontroller and the peripheral circuit as the controller 30. All or part of the processing performed by the processor may be performed by a dedicated electronic circuit.

### 1.13 States of Upper Wall of Shielding Container, Sensor, and Opening/Closing Mechanism, and Detected Temperature

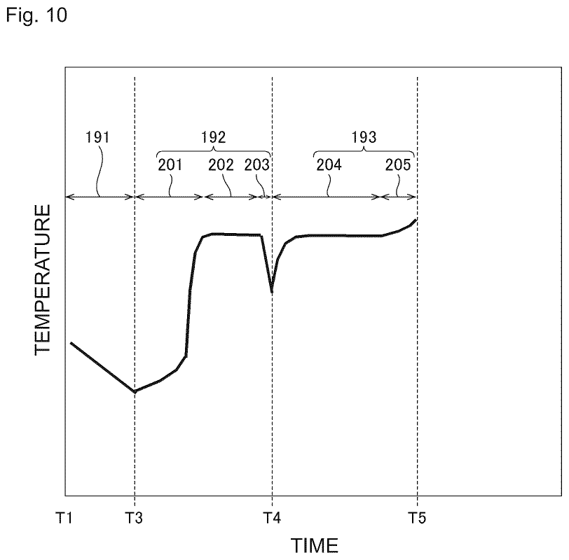

FIGS. 5 to 9 are cross-sectional views schematically illustrating states of the upper wall of the shielding container, the sensor, and the opening/closing mechanism included in the treatment device of the first embodiment when the treatment device performs the operation of drying the object to be treated. FIG. 10 is a graph illustrating a temporal change of the temperature indicated by the signal output from the sensor included in the treatment device of the first embodiment when the treatment device performs the operation of drying the object to be treated.

FIGS. 5 to 9 schematically illustrate a state in a case where the control of Control Example 3 described above is performed. FIG. 10 illustrates a time change in a case where the control of Control Example 3 described above is performed. In FIG. 10, the horizontal axis represents the time elapsed after the treatment device 1 starts the operation for drying the object to be treated 11, and the vertical axis represents the temperature indicated by the signal output by the sensor 26.

In a period (hereinafter, it is referred to as a “period before heating start”) 191 from timing T1 when the decompression mechanism 25 starts decompressing to timing T3 when the dielectric heating mechanism 24 starts heating, the lid 161 is disposed at the first position as illustrated in FIG. 5. Therefore, the signal output by the sensor 26 indicates the temperature of the object to be treated 11.

In the period 191 before heating start, the object to be treated 11 is not heated, and the decompression space 21p of the shielding container 21 is decompressed. Therefore, water is gently evaporated from the object to be treated 11. Therefore, as illustrated in FIG. 5, dew condensation water hardly adheres to the upper wall 51, the sensor 26, and the lid 161 of the shielding container 21. Furthermore, as illustrated in FIG. 10, the temperature indicated by the signal output by the sensor decreases as time passes. Therefore, the temporal change rate of the temperature is negative.

The period (hereinafter, it is referred to as a “period after heating is started”) 192 from timing T3 at which the dielectric heating mechanism 24 starts heating to timing T4 at which the opening/closing mechanism 27 switches the opening/closing state of the opening 21b of the shielding container 21 from the first state to the second state is divided into a first period 201, a second period 202, and a third period 203.

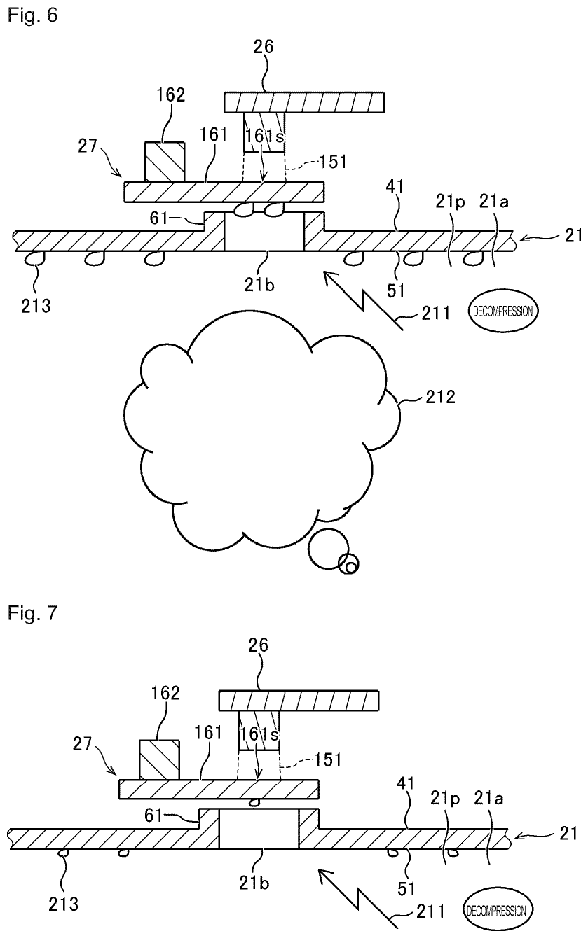

In the first period 201, as illustrated in FIG. 6, the lid 161 is disposed at the second position. Therefore, the signal output by the sensor 26 indicates the temperature of the lid 161.

In the first period 201, the object to be treated 11 is heated by the microwave 211, and the decompression space 21p of the shielding container 21 is decompressed. Therefore, water is intensely evaporated from the object to be treated 11 to generate water vapor 212. Therefore, as illustrated in FIG. 6, dew condensation water 213 adheres to the upper wall 51 and the lid 161 of the shielding container 21. In the first period 201, the dew condensation water 213 is heated by the microwave 211. Therefore, in the first period 201, as illustrated in FIG. 10, the temperature indicated by the signal output from the sensor 26 increases as time passes. Therefore, the temporal change rate of the temperature is positive.

In the following second period 202, the object to be treated 11 is heated by the microwave 211, and the decompression space 21p of the shielding container 21 is decompressed. Therefore, in the second period 202, water evaporates from the object to be treated 11, but the evaporation of water becomes gentle as compared with the first period 201. Therefore, in the second period 202, the dew condensation water 213 adheres to the upper wall 51 and the lid 161 of the shielding container 21, but the adhesion of the dew condensation water 213 is reduced as compared with the first period 201. In the second period 202, the adhered dew condensation water 213 is heated by the microwave 211. The adhered dew condensation water 213 evaporates. Adhesion of the dew condensation water 213 to the lid 161 and evaporation of the dew condensation water 213 adhered to the lid 161 are substantially balanced. Therefore, in the second period 202, as illustrated in FIG. 10, the temperature indicated by the signal output from the sensor 26 is substantially maintained even after the lapse of time. Therefore, the temporal change rate of the temperature is approximately 0.

In the subsequent third period 203, as illustrated in FIG. 7, the lid 161 is placed in the second position. Therefore, the signal output by the sensor 26 indicates the temperature of the lid 161.

In the third period 203, the object to be treated 11 is heated by the microwave 211, and the decompression space 21p of the shielding container 21 is decompressed. Therefore, in the third period 203, water evaporates from the object to be treated 11, but the evaporation of water becomes gentle as compared with the second period 202. Therefore, in the third period 203, the dew condensation water 213 adheres to the upper wall 51 and the lid 161 of the shielding container 21, but the adhesion of the dew condensation water 213 is reduced as compared with the second period 202. In the third period 203, the adhered dew condensation water 213 is heated by the microwave 211. The dew condensation water 213 adhering to the lid 161 evaporates. Evaporation of the dew condensation water 213 adhering to the lid 161 becomes dominant over adhesion of the dew condensation water 213 to the lid 161. Therefore, in the third period 203, as illustrated in FIG. 10, the temperature indicated by the signal output from the sensor 26 decreases as time passes. Therefore, the temporal change rate of the temperature is negative.

The controller 30 causes the opening/closing mechanism 27 to switch the opening/closing state of the opening 21b of the shielding container 21 from the second state to the first state at timing T4 at which it is detected that the temporal change rate in temperature indicated by the signal output from the sensor 26 in the third period 203 becomes a negative value satisfying the set condition. As a result, after causing the opening/closing mechanism 27 to switch the opening/closing state of the opening 21b from the first state to the second state, the controller 30 causes the opening/closing mechanism 27 to switch the opening/closing state of the opening 21b from the second state to the first state when the temporal change rate becomes a negative value satisfying the set condition. As a result, the acquisition of the temperature of the object to be treated 11 can be resumed after the evaporation of the water becomes gentle and the possibility that the water vapor may fog the sensor 26 is reduced. This makes it possible to detect completion of drying of the object to be treated 11 based on the temperature of the object to be treated 11. The condition to be satisfied by the temporal change rate is, for example, a condition that the temporal change rate is equal to or less than a negative threshold. The negative threshold is set to be smaller than a negative value that the temporal change rate may have in the second period 202.

The period (hereinafter, it is referred to as a “period after opening”) 193 from timing T4 at which the opening/closing mechanism 27 switches the opening/closing state of the opening 21b of the shielding container 21 from the first state to the second state to timing T5 at which the dielectric heating mechanism 24 ends heating and the decompression mechanism 25 ends decompressing is divided into a fourth period 204 and a fifth period 205.

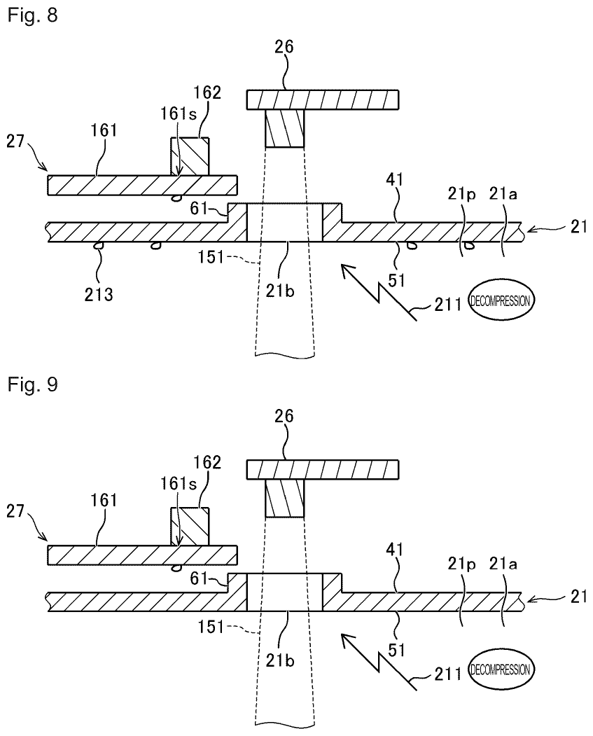

In the fourth period 204, as illustrated in FIG. 8, the lid 161 is disposed at the first position. Therefore, the signal output by the sensor 26 indicates the temperature of the object to be treated 11.

In the fourth period 204, the object to be treated 11 is heated by the microwave 211, and the decompression space 21p of the shielding container 21 is decompressed. Therefore, in the fourth period 204, water evaporates from the object to be treated 11, but the evaporation of water becomes gentle as compared with the third period 203. Heating of the object to be treated 11 by the microwave 211 and evaporation of water from the object to be treated 11 are substantially balanced. Therefore, in the fourth period 204, as illustrated in FIG. 10, the temperature indicated by the signal output from the sensor 26 is substantially maintained even after the lapse of time after the transition period accompanying the change of the temperature detection target from the lid 161 to the object to be treated 11 is ended. Therefore, the temporal change rate in the temperature is approximately 0 after the transition period is ended.

In the subsequent fifth period 205, as illustrated in FIG. 9, the lid 161 is placed in the first position. Therefore, the signal output by the sensor 26 indicates the temperature of the object to be treated 11.

In the fifth period 205, the object to be treated 11 is heated by the microwave 211, and the decompression space 21p of the shielding container 21 is decompressed. However, the drying of the object to be treated 11 is substantially ended. Therefore, in the fifth period 205, water hardly evaporates from the object to be treated 11. Heating of the object to be treated 11 by the microwave 211 is more dominant than evaporation of water from the object to be treated 11. Therefore, in the fifth period 205, as illustrated in FIG. 10, the temperature indicated by the signal output from the sensor 26 increases as time passes. Therefore, the temporal change rate of the temperature is positive.

At timing T5 when the controller 30 detects that the temporal change rate in temperature indicated by the signal output from the sensor 26 in the fifth period 205 becomes a positive value satisfying the set condition, the controller 30 causes the dielectric heating mechanism 24 to end heating, and causes the decompression mechanism 25 to end depressurization. As a result, after the drying of the object to be treated 11 is ended, the operation for drying the object to be treated 11 can be ended.

The present disclosure is not limited to the above embodiment, and may be replaced with a configuration substantially identical to the configuration described in the above embodiment, a configuration having the same function and effect, or a configuration capable of achieving the same object.

1. A treatment device comprising:
a container having formed therein an internal space for accommodating an object to be treated, and an opening leading from the internal space to an outside of the container;
a heating mechanism configured to heat the internal space;
a decompression mechanism configured to decompress the internal space;
a sensor configured to output a signal corresponding to infrared rays arriving from the internal space through the opening; and
an opening/closing mechanism configured to switch a state between a first state, in which the opening is opened, and a second state, in which the opening is closed.

2. The treatment device according to claim 1, wherein the heating mechanism is a dielectric heating mechanism that radiates microwaves into the internal space.

3. The treatment device according to claim 2, wherein the container is a shielding container that shields the microwave.

4. The treatment device according to claim 3, wherein the shielding container includes a portion made of a conductor.

5. The treatment device according to claim 3, wherein
the internal space is a first internal space,
the internal space includes a vacuum container in which a second internal space for accommodating the shielding container is formed, and
the decompression mechanism decompresses the second internal space.

6. The treatment device according to claim 5, wherein a vent hole that extends from the internal space to an outside of the container and is not closed when the state becomes the second state is formed in the shielding container.

7. The treatment device according to claim 1, wherein
the opening/closing mechanism includes:
a lid; and
a moving mechanism that moves the lid between a first position at which the opening is not closed and a second position at which the opening is closed.

8. The treatment device according to claim 7, wherein
the heating mechanism is a dielectric heating mechanism that radiates microwaves into the internal space, and
the lid includes a portion made of a conductor.

9. The treatment device of claim 8, wherein
the lid has a surface that is disposed within a visual field of the sensor when the lid is positioned at the second position, and
the surface exhibits black color.

10. The treatment device according to claim 9, wherein
the infrared rays are first infrared rays, and
the sensor outputs a signal corresponding to the first infrared rays in a case where the lid is disposed at the first position, and outputs a signal corresponding to second infrared rays arriving from the lid in a case where the lid is disposed at the second position.

11. The treatment device according to claim 1, further comprising a controller that causes the opening/closing mechanism to switch the state from the first state to the second state before causing the heating mechanism to start heating the internal space or at the same time as causing the heating mechanism to start heating the internal space.

12. The treatment device according to claim 1, further comprising a controller that causes the opening/closing mechanism to switch the state from the first state to the second state after causing the decompression mechanism to start depressurizing the internal space or at the same time as causing the decompression mechanism to start depressurizing the internal space.

13. The treatment device according to claim 1, further comprising a controller that causes the opening/closing mechanism to switch the state from the second state to the first state in a case where a temporal change rate in temperature indicated by the signal becomes a negative value that satisfies a set condition after causing the opening/closing mechanism to switch the state from the first state to the second state.
